(19) United States
(12) Patent Application Publication
(10) Pub. No.: US 2026/0222223 A1
(43) Pub. Date: Jul. 30, 2026

(54) HANDLING SECURITY FOR CONCATENATED PACKETS IN TELECOMMUNICATION NETWORK

(71) Applicant: Samsung Electronics Co., Ltd., Suwon-si, Gyeonggi-do (KR)

(72) Inventors: Aneesh Narendra DESHMUKH, Bangalore (IN); Nayan OSTWAL, Bangalore (IN); Neha SHARMA, Bangalore (IN); Anshuman NIGAM, Bangalore (IN); Mahantesh KOTHIWALE, Bangalore (IN)

(21) Appl. No.: 19/143,224

(22) PCT Filed: Feb. 19, 2024
(86) PCT No.: PCT/KR2024/095402

§ 371 Date: Jun. 25, 2025

(30) Foreign Application Priority Data
Feb. 28, 2023 (IN) 202341013374
Jan. 4, 2024 (IN) 2023 41013374

(51) Int. Cl. H04L 9/32; H04L 69/22; H04L 69/321; H04L 69/324; H04W 12/033; H04W 12/106; H04W 12/108

(52) U.S. Cl. CPC H04L 9/3247; H04L 69/22; H04L 69/321; H04L 69/324; H04W 12/033; H04W 12/106; H04W 12/108

(57) ABSTRACT

The present disclosure relates to a 5G communication system or a 6G communication system for supporting higher data rates beyond a 4G communication system such as long term evolution (LTE). Embodiments herein provide a method and device for handling security for concatenated packets in telecommunication network. The method includes receiving by a transmitter device (130) a plurality of SDU packets (502-508) from a higher layer to a Layer (L2) of the transmitter device (130). The same SN assigned to each SDU packets of the plurality of SDU packets (502-508) to form a single PDU packet (520c) and generating a first label unique security signature (510-516) based on the assigned SN number. Further, encrypting, each SDU packet of the plurality of SDU packets (502-508) with the first label unique security signature (510-516), except for the L2 packet header (518). The receiver device deciphers the received each SDU packets of the plurality of SDU packets (502-508) irrespective of missing segments or received in out of order.

### TECHNICAL FIELD

The present disclosure relates to the field of telecommunication network. More particularly proposed disclosure is related to a method and a device for handling security for concatenated packets in a telecommunication network.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The principal object of the embodiments herein is to provide a transmitter device, a receiver device and a method thereof for handling security for concatenated packets in telecommunication network. The proposed disclosure includes implementing ciphering and integrity protection functionalities for each Service Data Unit (SDU) in a CL2, before the formation of a Protocol Data Unit (PDU) via a PDCP. By doing so, the proposed disclosure ensures that the data being transmitted wirelessly is kept confidential.

Another object of the embodiments herein is to establish security for concatenated packets at the PDCP or L2 operation, rather than at the PDU level. Each of the multiple SDU packets is equipped with security parameters, which are determined by means of a Message Authentication Code-Integrity (MAC-I) or a distinct label-based security signature. The MAC-I serves to ensure the authenticity and integrity of the data transmitted during communication.

Yet another object of the embodiments herein is to achieve independence from the security operations on the PDU, enabling the deciphering of each SDU packet separately, rather than having the dependency on the entire PDU and waiting for it to be received, under certain operational instances.

Another object of the embodiments herein is to establish security procedures for a clustered packet. Clustering of packets provide efficiency and reduces overall computational processing load. However, performing security operation on the clustered PDU can have certain limitations either to be performed in Software (SW) or using dedicated Security Accelerators (SA) in hardware (HW). This objective is accomplished through a streamlined solution that utilizes to encrypt the PDU efficiently.

Yet another object of the embodiments herein is to generate a single second label that serves as a distinctive security signature for only the L2 Header, ensuring the integrity of the L2 PDU while also allowing for the placement of the generated second label before or after the L2 PDU, providing added flexibility.

Yet another object of the embodiments herein is to determine security parameters based on the operational state of channels. Specifically, optimal security parameters are applied to clustered SDUs in high-quality channels, while less effective parameters are utilized for individual SDU packets in poor channels amongst the plurality of SDUs.

Yet another object of the embodiments herein is to perform per-packet security measures prior to Protocol operations, while also proposing novel fields for generating security keys. Additionally, security operations are carried out independently on the receiver's end, without relying on complete packet reception. This effectively reduces packet latency under certain operating scenarios.

The present invention has been made to address at least the above problems and/or disadvantages and to provide at least the advantages described below. Accordingly, an aspect of the present invention provides a method and apparatus for handling security for concatenated packet in telecommunication network.

### Solution to Problem

In an aspect, the objectives are achieved by handling security for concatenated packets in a telecommunication network through a transmitter device, a receiver device and method thereof. The method includes receiving, by the transmitter device, a plurality of SDU packets from a Higher Layer to a Layer (L2) of the transmitter device. Further, the method includes assigning, by the transmitter device at the L2, the same Sequence Number (SN) to each SDU packets of the plurality of SDU packets to form a single PDU packet based on concatenation of the plurality of SDU packets. Further, the method includes generating, by the transmitter device, a first label unique security signature for each SDU packet of the plurality of SDU packets based on the assigned SN number and a plurality of security parameters. Furthermore, the method includes encrypting, by the transmitter device, each SDU packet of the plurality of SDU packets and the first label unique security signature corresponding to each SDU packet of the plurality of SDU packets, except for the L2 packet header. Thereafter, the method includes, by the transmitter device, buffer each encrypted SDU packet of the plurality of encrypted SDU packets.

In one embodiment, encrypted SDU packet from the plurality of encrypted SDU packets includes adding a L2 header and a Length Indicator (LI) to the encrypted SDU packets, thereby forming the PDU packet upon reception. When configured, the method generates a second label unique security signature for the PDU packet header based on the assigned SN number and the security parameters. This signature is added to the PDU header, either before or after the L2 header and length indicator. By incorporating the MAC for the encrypted SDU packets, the decryption of each encrypted SDU packet is possible, regardless of whether the receiver receives segments in an out-of-order or missing sequence. Further, the method buffers each encrypted SDU packet from the plurality of encrypted SDU packets.

In an embodiment, the method includes reserving at least one bit in the header of the PDU packet to indicate a presence of the second label unique security signature for the header of the PDU packet.

In an embodiment, the method of generating the first label unique security signature for each SDU packet of the plurality of SDU packets comprises determining whether a security option is to be performed. Further, the method includes generating the first label unique security signature for each SDU packet of the plurality of SDU packets when the security operation is to be performed.

In an embodiment, generating the first label unique security signature for each SDU packet of the plurality of SDU packets. The method includes, determining, whether the PDU packet is formed based on a concatenation of plurality of SDU packets. The method includes, determining, whether a security option is to be performed when the PDU packet is formed based on the concatenation. Further the method includes, generating the first label unique security signature for each SDU packet of the plurality of SDU packets when the security operation is to be performed.

In an embodiment, encrypting each SDU packet of the plurality of SDU packets and corresponding the first label unique security signature generated for each SDU packet of the plurality of SDU packets comprises adding, by the transmitter device, the first label unique security signature to each SDU packet of the plurality of SDU packets.

The method includes, encrypting each SDU packet of the plurality of SDU packets and the first label unique security signature generated for each SDU packet of the plurality of SDU packets.

In an embodiment, plurality of the security parameters comprises at least one of but not limited to a direction of an uplink and a downlink data transmission, a bearer identifier, a key integrity of each SDU packet of the plurality of SDU packets, and a location of the plurality of SDU packets in the PDU packet. The location of the SDU packets in the PDU can be byte offset as counted from the beginning of the PDU data payloads or the position of the SDU in the original PDU enumerated using 1st, 2nd, 3rd or so on.

Accordingly, the embodiment herein is to provide a method for handling security for concatenated packets in a telecommunication network. The receiver device receiving a first segment of encrypted SDU packets from a transmitter device. The method includes, detecting the SN associated with each SDU packet in the first segment of the encrypted SDU packets and a first label unique security signature associated with the first segment of the encrypted SDU packets. The method includes, decrypting each encrypted SDU packet from the first segment of encrypted SDU packets based on the first label unique security signature and the relevant header field confirming the presence of the complete SDU in the first segment, and in some cases, waiting for receiving at least one second segment of the encrypted SDU packets. The method includes, decrypting each SDU packet from the first segment of encrypted SDU packets based on the first label unique security signature associated with the at least one second segment of encrypted SDU packets after combining the segments to form a complete SDU. Further, the method includes, forming a complete SDU by concatenating the first segments of the first segment of SDU packets and the at least one second segment of SDU packets and then decrypting it together.

In an embodiment, decrypting each SDU packet of the plurality of SDU packets and corresponding the first label unique security signature generated for each SDU packet of the plurality of SDU packets. The method includes removing, by the receiver device, the first label unique security signature to each SDU packet of the plurality of SDU packets. The method includes, decrypting each SDU packet of the plurality of SDU packets and confirming the first label unique security signature generated for each SDU packet of the plurality of SDU packets.

In an embodiment, detecting the first label unique security signature for each SDU packet of the plurality of SDU packets. The method includes identifying, by the receiver device, whether a security operation is to be performed. The method includes detecting, by the receiver device, the first label unique security signature for each SDU packet of the plurality of SDU packets when the security operation is to be performed.

Accordingly, the embodiment herein is to provide a transmitter device for handling security for concatenated packets in a telecommunication network. The transmitter device comprises a memory, a processor and a security handling unit is communicatively coupled to the memory and the processor. The transmitter device is configured to receive a plurality of SDU packets from a Higher Layer to a Layer (L2) of the transmitter device. The security handling unit assigns the same SN to each SDU packets of the plurality of SDU packets to form a single PDU packet based on concatenation of the plurality of SDU packets. The security handling unit generates a first label unique security signature for each SDU packet of the plurality of SDU packets based on the assigned SN number and a plurality of configured security parameters. These security parameters can be configured by the common control plane between the transmitter and the receiver. Further, the security handling device encrypts each SDU packet of the plurality of SDU packets and the first label unique security signature corresponding to each SDU packet of the plurality of SDU packets, except for the L2 packet header and buffers each encrypted SDU packet of the plurality of encrypted SDU packets. Accordingly, the embodiment herein is to provide the receiver device for handling security for concatenated packets in a telecommunication network comprises a memory, a processor, a protocol and a security handling unit communicatively coupled to the memory and the processor, are configured to receive the packets from a transmitter device. The received packets contains the SN and other information related to the packet whether it is complete or segmented. The security handling unit detects the SN associated with each SDU packet in the complete or received segment of the encrypted SDU packets and a first label unique security signature associated with the first segment of the encrypted SDU packets. The security handling unit decrypts each encrypted SDU packet that is complete from the first and compares the first label unique security signature.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and network for handling security for concatenated packet in telecommunication network.

### BRIEF DESCRIPTION OF DRAWINGS

These and other features, aspects, and advantages of the proposed disclosure are illustrated in the accompanying drawings, throughout which like reference letters indicate corresponding parts in the various figures. The embodiments herein will be better understood from the following description with reference to the drawings, in which:

FIG. 1a is a block diagram that illustrates a scenario in which 4G RAN security processing for SRBs, according to prior art;

FIG. 1b is a block diagram that illustrates a scenario in which 4G RAN security processing for DRBs, according to the prior;

FIG. 1c is a block diagram that illustrates a scenario in which 5G RAN security processing for both SRBs and DRBs, according to the prior art as disclosed herein;

FIG. 2a is a block diagram that illustrates a Converged Layer2 (CL2), according to the prior art as disclosed herein;

FIG. 2b is a flow diagram that illustrates NR procedures for assigning different SNs to each PDCP SDUs, according to the prior art as disclosed herein;

FIG. 3 is a flow diagram that illustrates performing security measures for every SDU in managing the security of concatenated packets within a telecommunication network, according to the embodiment as disclosed herein;

FIG. 4 is a block diagram that illustrates segmentation handling procedure for handling security of the concatenated packets in the telecommunication network, according to the embodiment as disclosed herein;

FIG. 5 is a block diagram that illustrates implementation of security parameters through the assignment of the LI field at the header location, thereby facilitating seamless security handling in the CL2 protocol stack for 6G, according to the embodiment as disclosed herein;

FIG. 6 is a block diagram that illustrates placement of MAC-Is at SDUs locations within the PDU for handling security of the concatenated packets in the telecommunication network, according to the embodiment as disclosed herein;

FIG. 7 is a block diagram that illustrates generating a MAC-I for both L2 and LI fields combined, serving as an extra layer of security in managing concatenated packets within the telecommunication network, according to the embodiment as disclosed herein;

FIG. 8 is a block diagram that illustrates generating the LI for each SDUs to manage security for concatenated packets in the telecommunication network, according to the embodiment as disclosed herein;

FIG. 9 is a flow diagram that illustrates a method for providing security parameters for the PDU to enhance security handling in the CL2 protocol stack for 6G, according to the embodiment as disclosed herein;

FIG. 10 is a block diagram that illustrates generation of a single LI field for PDU for security handling of the concatenated packets in the telecommunication network, according to the embodiment as disclosed herein;

FIG. 11 is a block diagram that illustrates generation of LI fields for each SDUs and forming PDU in the telecommunication network, according to the embodiment as disclosed herein;

FIG. 12 is a block diagram that illustrates the application of security parameters to the PDCP concatenation in a direct manner on the 5G RAN system, according to the embodiment as disclosed herein;

FIG. 13a is a block diagram of a transmitter device designed to manage security measures for the concatenated packets within the telecommunication network, according to the embodiment as disclosed herein;

FIG. 13b is a block diagram of a receiver device designed to manage security measures for the concatenated packets within the telecommunication network, according to the embodiment as disclosed herein;

FIG. 14a is a flow diagram that illustrates a method implemented by the transmitter device for handling security for concatenated packets in a telecommunication network, according to the embodiment as disclosed herein;

FIG. 14b is a flow diagram that illustrates a method implemented by the receiver device for handling security for concatenated packets in a telecommunication network, according to the embodiment as disclosed herein;

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

In recent years, wireless technology has undergone significant development to cater to the increasing number of users, providing better application services and security parameters. The second generation (2G) wireless communication was designed to provide voice services while ensuring user mobility. Third generation (3G) wireless communication not only supports voice services but also data services. Fourth generation (4G) and fifth generation (5G) wireless communication have been developed to provide high-speed data services. However, while 4G, Long-Term Evolution (LTE), and 5G wireless communication. 6G networks, and other advance wireless networks offer high-speed data services, they lack in security parameters

The Radio Access Network (RAN) protocols for 4G and 5G networks include the Packet Data Convergence Protocol (PDCP), Radio Link Control (RLC), Medium Access Control (MAC), and PHY protocol. Additionally, a control plane stack comprises Radio Resource Control (RRC) and Non-Access Stratum (NAS).

The PDCP layer plays a crucial role in ensuring secure transmission of IP (Internet Protocol) packets in wireless communication networks. It operates within the protocol stack and is responsible for applying security measures such as, encryption and validation or authentication, apart from other functionalities for transfer of data, header compression, error detection, recovery, and traffic management. These measures ensure a high-quality service and integration with higher layers. The PDCP layer provides service to Signaling Radio Bearers (SRBs) and Data Radio Bearers (DRBs) including ciphering and integrity protection for securing the transmitted data.

The SRBs and DRBs are utilized for communication between User Equipment (UE) and the network. The SRBs carry control plane signaling, assist in resource management, and are essential for both initial connection setup and continuous control plane information exchange. On the other hand, DRBs are more dynamic and adaptable and serve a wider type of data transfer, and their creation is based on the user's data transfer requirements. SRBs and DRBs carry signaling information and user data, respectively, related to the user data, providing a reliable method for efficient data transfer.

In 4G networks, ciphering and integrity protection are applied to SRBs, while DRBs are only ciphered.

In 5G wireless technology, security functionalities such as ciphering and integrity protection are applied to SRBs, while DRBs are ciphered with integrity protection as an optional feature. The PDCP layer supports limited security operations for data transmission during wireless communication in both 4G and 5G based on it is processing capability. As the demand for high-speed data services increases, advanced sixth generation (6G) and future wireless technologies are being developed to enhance performance in data transmission between the network and UE. To overcome this problem, advanced protocol design options like Converged Layer 2 (CL2) are being considered for 6G and future generations of wireless communication. CL2 is a convergence of multiple L2 protocols in the network for example PDCP and RLC layers of NR. The Layer 2 or L2 also refers to the data link layer in an Open Systems Inter-connection (OSI) model that is responsible for framing, addressing, and error detection at the link layer. However, with advancements in wireless technologies, it is crucial to implement advanced security measures to prevent security breaches from rogue elements such as false base stations, cyber-attacks, and other security breaches.

Thus, it is desired to address the above-mentioned disadvantages or other shortcomings or at least provide a useful alternative to handle the data security for the 6G and next generation communication technology.

In an aspect, the objectives are achieved by handling security for concatenated packets in a telecommunication network through a transmitter device, a receiver device and method thereof. The method includes receiving, by the transmitter device, a plurality of SDU packets from a Higher Layer to a Layer (L2) of the transmitter device. Further, the method includes assigning, by the transmitter device at the L2, the same Sequence Number (SN) to each SDU packets of the plurality of SDU packets to form a single PDU packet based on concatenation of the plurality of SDU packets.

Further, the method includes generating, by the transmitter device, a first label unique security signature for each SDU packet of the plurality of SDU packets based on the assigned SN number and a plurality of security parameters. Furthermore, the method includes encrypting, by the transmitter device, each SDU packet of the plurality of SDU packets and the first label unique security signature corresponding to each SDU packet of the plurality of SDU packets, except for the L2 packet header. Thereafter, the method includes, by the transmitter device, buffer each encrypted SDU packet of the plurality of encrypted SDU packets.

In one embodiment, encrypted SDU packet from the plurality of encrypted SDU packets includes adding a L2 header and a Length Indicator (LI) to the encrypted SDU packets, thereby forming the PDU packet upon reception. When configured, the method generates a second label unique security signature for the PDU packet header based on the assigned SN number and the security parameters. This signature is added to the PDU header, either before or after the L2 header and length indicator. By incorporating the MAC for the encrypted SDU packets, the decryption of each encrypted SDU packet is possible, regardless of whether the receiver receives segments in an out-of-order or missing sequence. Further, the method buffers each encrypted SDU packet from the plurality of encrypted SDU packets.

In an embodiment, the method includes reserving at least one bit in the header of the PDU packet to indicate a presence of the second label unique security signature for the header of the PDU packet.

In an embodiment, the method of generating the first label unique security signature for each SDU packet of the plurality of SDU packets comprises determining whether a security option is to be performed. Further, the method includes generating the first label unique security signature for each SDU packet of the plurality of SDU packets when the security operation is to be performed.

In an embodiment, generating the first label unique security signature for each SDU packet of the plurality of SDU packets. The method includes, determining, whether the PDU packet is formed based on a concatenation of plurality of SDU packets. The method includes, determining, whether a security option is to be performed when the PDU packet is formed based on the concatenation. Further the method includes, generating the first label unique security signature for each SDU packet of the plurality of SDU packets when the security operation is to be performed.

In an embodiment, encrypting each SDU packet of the plurality of SDU packets and corresponding the first label unique security signature generated for each SDU packet of the plurality of SDU packets comprises adding, by the transmitter device, the first label unique security signature to each SDU packet of the plurality of SDU packets. The method includes, encrypting each SDU packet of the plurality of SDU packets and the first label unique security signature generated for each SDU packet of the plurality of SDU packets.

In an embodiment, plurality of the security parameters comprises at least one of but not limited to a direction of an uplink and a downlink data transmission, a bearer identifier, a key integrity of each SDU packet of the plurality of SDU packets, and a location of the plurality of SDU packets in the PDU packet. The location of the SDU packets in the PDU can be byte offset as counted from the beginning of the PDU data payloads or the position of the SDU in the original PDU enumerated using 1st, 2nd, 3rd or so on.

Accordingly, the embodiment herein is to provide a method for handling security for concatenated packets in a telecommunication network. The receiver device receiving a first segment of encrypted SDU packets from a transmitter device. The method includes, detecting the SN associated with each SDU packet in the first segment of the encrypted SDU packets and a first label unique security signature associated with the first segment of the encrypted SDU packets. The method includes, decrypting each encrypted SDU packet from the first segment of encrypted SDU packets based on the first label unique security signature and the relevant header field confirming the presence of the complete SDU in the first segment, and in some cases, waiting for receiving at least one second segment of the encrypted SDU packets. The method includes, decrypting each SDU packet from the first segment of encrypted SDU packets based on the first label unique security signature associated with the at least one second segment of encrypted SDU packets after combining the segments to form a complete SDU. Further, the method includes, forming a complete SDU by concatenating the first segments of the first segment of SDU packets and the at least one second segment of SDU packets and then decrypting it together.

In an embodiment, decrypting each SDU packet of the plurality of SDU packets and corresponding the first label unique security signature generated for each SDU packet of the plurality of SDU packets. The method includes removing, by the receiver device, the first label unique security signature to each SDU packet of the plurality of SDU packets. The method includes, decrypting each SDU packet of the plurality of SDU packets and confirming the first label unique security signature generated for each SDU packet of the plurality of SDU packets.

In an embodiment, detecting the first label unique security signature for each SDU packet of the plurality of SDU packets. The method includes identifying, by the receiver device, whether a security operation is to be performed. The method includes detecting, by the receiver device, the first label unique security signature for each SDU packet of the plurality of SDU packets when the security operation is to be performed.

Accordingly, the embodiment herein is to provide a transmitter device for handling security for concatenated packets in a telecommunication network. The transmitter device comprises a memory, a processor and a security handling unit is communicatively coupled to the memory and the processor. The transmitter device is configured to receive a plurality of SDU packets from a Higher Layer to a Layer (L2) of the transmitter device. The security handling unit assigns the same SN to each SDU packets of the plurality of SDU packets to form a single PDU packet based on concatenation of the plurality of SDU packets. The security handling unit generates a first label unique security signature for each SDU packet of the plurality of SDU packets based on the assigned SN number and a plurality of configured security parameters.

These security parameters can be configured by the common control plane between the transmitter and the receiver. Further, the security handling device encrypts each SDU packet of the plurality of SDU packets and the first label unique security signature corresponding to each SDU packet of the plurality of SDU packets, except for the L2 packet header and buffers each encrypted SDU packet of the plurality of encrypted SDU packets. Accordingly, the embodiment herein is to provide the receiver device for handling security for concatenated packets in a telecommunication network comprises a memory, a processor, a protocol and a security handling unit communicatively coupled to the memory and the processor, are configured to receive the packets from a transmitter device. The received packets contains the SN and other information related to the packet whether it is complete or segmented. The security handling unit detects the SN associated with each SDU packet in the complete or received segment of the encrypted SDU packets and a first label unique security signature associated with the first segment of the encrypted SDU packets. The security handling unit decrypts each encrypted SDU packet that is complete from the first and compares the first label unique security signature.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits are logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports are printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The terms transmitter and transmitter device are used interchangeably. The terms receiver and receiver device are used interchangeably.

Accordingly, the embodiments discloses a method for handling security for concatenated packets in a telecommunication network. The method includes receiving, by a transmitter device, a plurality of SDU packets from a Higher Layer to a Layer 2 (L2) of the transmitter device.

Accordingly, the embodiment herein a method for handling security for concatenated packets in a telecommunication network. The method includes receiving, by a transmitter device, a plurality of SDU packets from a Higher Layer to a Layer (L2) of the transmitter device. Further, the method includes assigning, by the transmitter device at the L2, the same Sequence Number (SN) to each SDU packets of the plurality of SDU packets to form a single PDU packet based on concatenation of the plurality of SDU packets. Thereafter, the method includes generating, by the transmitter device, a first label unique security signature for each SDU packet of the plurality of SDU packets based on the assigned SN number and a plurality of security parameters. Furthermore, the method includes encrypting, by the transmitter device, each SDU packet of the plurality of SDU packets and the first label unique security signature corresponding to each SDU packet of the plurality of SDU packets, except for the L2 packet header. Thereafter, the method includes, by the transmitter device, buffers each encrypted SDU packet of the plurality of encrypted SDU packets.

Accordingly, the embodiment herein is to provide a method for handling security for concatenated packets in a telecommunication network. The receiver device a first segment of encrypted SDU packets from a transmitter device. The method includes detecting the SN associated with each SDU packet in the first segment of the encrypted SDU packets and a first label unique security signature associated with the first segment of the encrypted SDU packets. The method includes decrypting each encrypted SDU packet from the first segment of encrypted SDU packets based on the first label unique security signature while receiving at least one second segment of the encrypted SDU packets. The method includes decrypting each SDU packet from the first segment of encrypted SDU packets based on the first label unique security signature associated with the at least one second segment of encrypted SDU packets.

Further, the method includes forming a PDU by concatenating the first segments of the first segment of decrypted SDU packets and the at least one second segment of decrypted SDU packets and then decrypting the complete SDU that is formed. The method includes, the complete SDUs in any of the segment, for which the segment boundary and the packet information can be correctly receive, and the received SDUs can be processed independently for the security when the received PDU is a valid PDU.

The transmitter device assigns the same SN to each SDU packets of the plurality of SDU packets to form a single PDU packet based on concatenation of the plurality of SDU packets. The transmitter device generates a first label unique security signature for each SDU packet of the plurality of SDU packets based on the assigned SN number and a plurality of security parameters. The transmitter device generates the packet header for L2 header. The transmitter device encrypts each SDU packet of the plurality of SDU packets and the first label unique security signature corresponding to each SDU packet of the plurality of SDU packets but does not encrypt the L2 packet header. Thereafter, the transmitter device buffers each encrypted SDU packet of the plurality of encrypted SDU packets.

Accordingly, the embodiment discloses a receiver device receiving the first segment of encrypted SDU packets from the transmitter device, detects the SN associated with each SDU packet in the first segment of the encrypted SDU packets and a first label unique security signature associated with the first segment of the encrypted SDU packets. The receiver device decrypts each encrypted complete SDU packet from the first segment of encrypted SDU packets based on the first label unique security signature while receiving at least one second segment of the encrypted SDU packets. Then decrypts each SDU packet from the first segment of encrypted SDU packets based on the first label unique security signature associated with the at least one second segment of encrypted SDU packets. Further, the receiver forms the PDU by concatenating the first segments of the first segment of encrypted SDU packets and the at least one second segment of encrypted SDU packets and then decrypting the complete SDU received from multiple segments and perform further additional security procedures based on the security option configured.

In the present scenario, the security measures for the 4G and 5G wireless technologies are not fully configured and lack one of the essential security parameters for the case of concatenation of the packet-ciphering for encoding and integrity protection for validation. The 4G and 5G security measures are defined for the security of individual SDUs that are received at PDCP layer and in turn form a PDCP PDU.

These security parameters are Radio Access Network (RAN) securities, which are applied to the wireless technology through a PDCP layer. In wireless communication, two bearers are used-Signaling Radio Bearers (SRBs) and Data Radio Bearers (DRBs)-for data transmission. Configuring both bearers with the necessary security features provides greater confidentiality and significantly reduces the risk of security breaches.

In 4G, only the SRBs are configured with security procedures and parameters for ciphering and integrity protection, while the DRBs are only ciphered but not integrity protected. In 5G, the SRBs are configured with security parameters for both ciphering and integrity protection, while integrity protection for DRBs is included as an option.

Unlike the conventional method, the proposed solution provides an innovative technical features for applying security parameters, such as ciphering and integrity protection, to concatenated SDU packets within a CL2. Unlike conventional methods, this solution involves adding a uniform SN to all SDUs and generating a first label for each SDU to represent a unique security signature prior to PDU formation. This enables the receiver to decipher and validate each received SDU independently, regardless of missing segments or out-of-order reception. Alternatively, the same SN can be added to all SDUs and a second label representing a unique security signature for the PDU can be generated after PDU formation at the transmitter. The receiver can then execute security operations, such as deciphering and validation, after receiving all the SDUs Concatenation of SDUs either at a common layer or at PDCP is going to be very much possible functionality for 6G and the specification need to evolve to consider the various possibilities to provide efficient security mechanism for the concatenated packets and provide security benefits to the various packets under concatenation.

Therefore, advanced security parameters are needed for the 6G or next-generation technologies to avoid security breaches.

The proposed disclosure boasts several unique technical features. Instead of performing security operations at the per PDU (Protocol Data Unit) level, as is traditionally done, the proposed solution performs security operations even before the PDU is formed, at the per SDU (Service Data Unit) level. This approach involves using the location of the SDU as an additional parameter for generating a unique Security Key for Integrity and Ciphering. The position key input can be based on either the Nth SDU in the PDU (starting from either 0 or 1 for the first SDU in the L2 PDU) or the Segment Offset of the starting of the PDU. In the subcase of using the Nth SDU in the PDU as an input key, it is possible to add an additional field to the L2 PDU Segment Header to inform the receiver which location the first SDU segment present in the L2 PDU header belongs to, allowing for correct deciphering without dependency on other segments. The proposed solution also allows for deciphering of packets regardless of missing segments and out-of-order ciphering on the receiver side. Additionally, the location of MAC-I generated for individual SDUs can be placed at multiple options within the header fields, with the option to separately integrity protect the header.

Finally, the proposed solution supports dynamic changes between multiple options of security processing based on channel conditions.

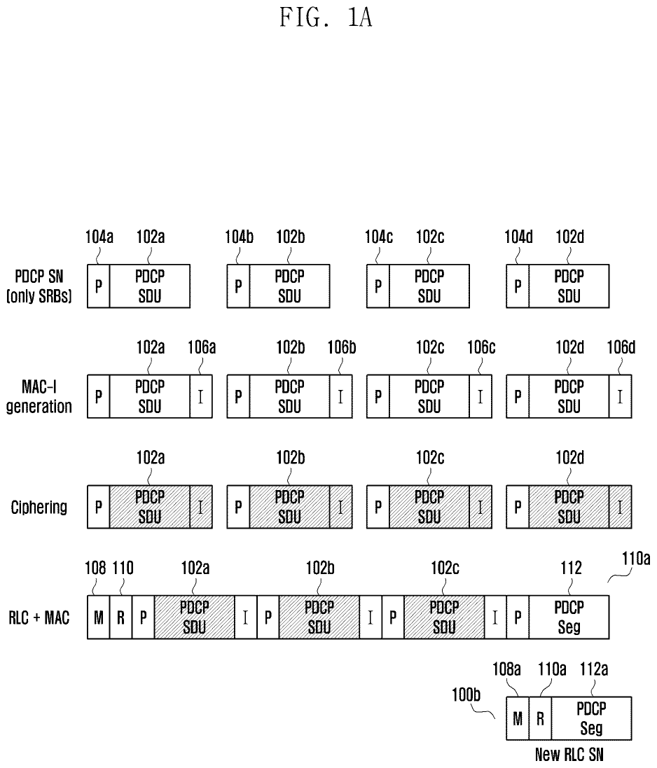

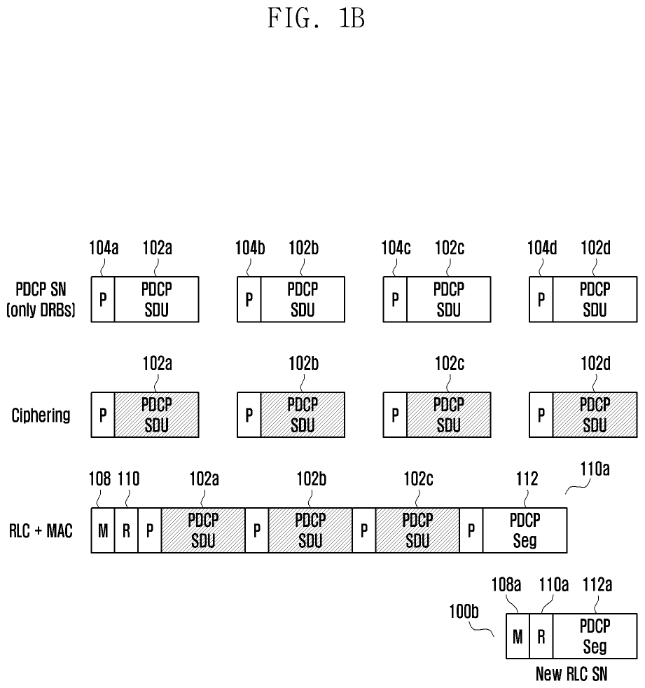

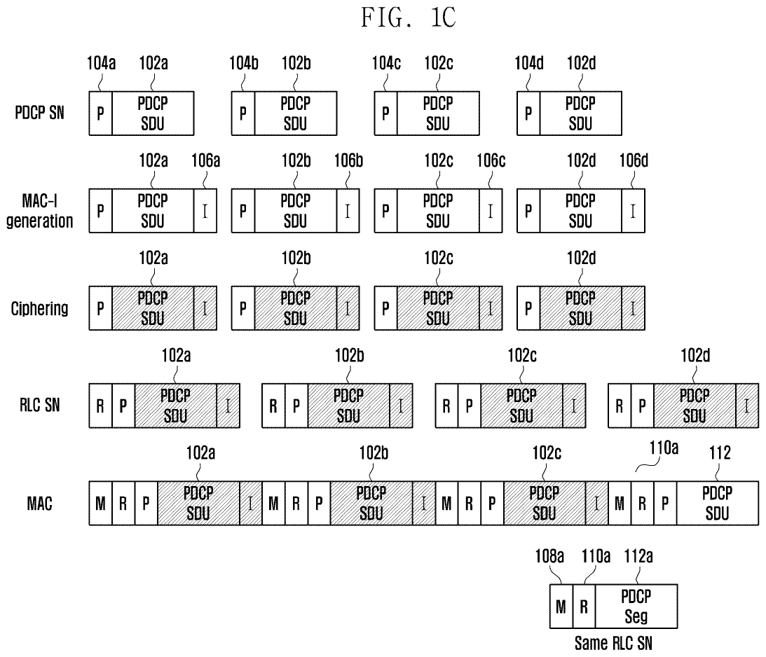

FIG. 1a is a block diagram that illustrates a scenario in which 4G RAN security processing for SRBs, according to prior art as disclosed herein.

Initially, a multitude of IP packets (also referred as plurality of IP packets) are received from the upper layer of a wireless technology transmitter device. The transmitter device described herein can include a range of devices, including but not limited to mobile devices, laptops, desktops, and the like. The upper layer may be an application layer. The received IP packets are then transmitted to the lower layers.

Specifically, the IP packets received at the PDCP layer can be referred to as Service Data Units (SDUs) (102a-d). In 4G, the transmitter assigns a sequence number to each of the PDCP SDUs (102a-d) and adds PDCP headers (104a-d) to each of the PDCP SDUs (102a-d) to form PDCP Protocol Data Units (PDUs). The PDCP PDUs are then authenticated by generating the Message Authentication Code-Integrity (MAC-I) at the PDCP Layer, where the PDCP SDUs (102a-d) are protected against integrity breaches by generating MAC-Is (106a-d) for each of the PDCP PDUs. The PDCP Header is also the part of MAC-I generation and implies that PDCP Header is integrity protected. Once the integrity protection is in place, each of the PDCP SDUs (102a-d) are encrypted, except for the PDCP Header. The MAC-I bits are also encrypted for additional security. The ciphered and integrity-protected PDCP SDUs (102a-d) are then transmitted to the Radio Link Control (RLC) layer. At the RLC layer, one or more PDCP SDUs (102a-d) are concatenated based on the grant received from the network or Medium Access Control (MAC) layer. Upon concatenation, an RLC header (R) (110) and MAC header (M) (108) are added to the concatenated PDCP SDUs (102a-d). Further, the concatenated packets (110a) are transmitted to the lower layer, which is the physical layer.

To ensure confidentiality and correct order of receipt at the receiver (100b), each PDCP SDU (102a-d) is assigned a unique SN and paired with a corresponding PDCP header (104a-d). These headers are placed at the beginning of the PDCP SDUs (102a-d). Additionally, MAC-Is (106a-d) are generated using the SNs as input to validate the data and are added to the end of each PDCP SDU (102a-d) to provide integrity and authenticity assurances. The resulting MAC-Is (106a-d) are added to the SRBs, but not to the DRBs. To prevent security breaches and add confidentiality, the security operation ciphering is configured on the PDCP SDUs (102a-d) with MAC-Is (106a-d), except for the PDCP headers (104a-d). Once encrypted, the PDCP SDUs (102a-d) are combined and passed to the RLC and MAC layer for transmission. The RLC adds its RLC header R (110) and the MAC layer adds its MAC header M (108) to the PDU (110a), which is placed at the beginning of the transmission. Further, the PDCP Seg (112) is added to optimize the transmission of the PDCP SDUs (102a-d).

In the FIG. 1A the receiver includes PDCP Seg (112a), R (110a) and M (110a). The security parameters in the 4G or Long-Term Evolution is applied on the SRBs only. In the SRBs i.e. RRC and NAS messages are ciphered and integrity protected but not on the DRBs. At the receiver, the PDCP SDUs (102a-d) are deciphered only when the PDCP Seg (112) from the transmitter device and PDCP Seg (112a) from the receiver device are combined in case if during the transmission from MAC, the PDCP packets gets fragmented due to grant sizes.

The PDCP SDUs (102a-d) are packets transmitted by the PDCP layer in the 4G or the LTE. It represents the data that is received from higher layers, and is prepared for transmission over the radio interface by adding the security parameters. The PDCP headers (104a-d) in the LTE wireless networks that facilitates functions are a header compression, a security, handovers, data transmission optimization and providing network efficiency over the data transmission. The MAC-Is (106a-d) provides the integrity protection for control plane messages, ensuring the authenticity and integrity of transmitted information. It is generated by using the SNs as input and included in the message header for verification at the receiving end. The MAC organizes and controls the PDCP SDUs (102a-d) exchange between the transmitter and the receiver. The MAC header M (108 and 108a) is responsible for managing access in the communication medium, including information about transmission parameters and control information. The RLC in wireless communication is used for a segmentation, a retransmission, and a flow control of the data transmission. The RLC header R (110 and 110a) includes details for segmentation, retransmission, and flow control by organizing PDCP SDUs (102a-d).

FIG. 1b is a block diagram that illustrates a scenario in which 4G RAN security processing for DRBs, according to the prior as disclosed herein. The security parameters are applied on the DRBs only. The transmitter includes a PDCP SDUs (102a-d) with different SNs, PDCP headers (104a-d), RLC header R (110), MAC sub header M (108), PDCP Seg (112) and the formed PDU (110a).

Each of the PDCP SDUs (102a-d) assigned with the PDCP headers (104a-d) including different SNs are placed at the beginning of the PDCP SDUs (102a-d) to ensure the PDCP SDUs (102a-d) are in correct order received at the receiver. The security operation ciphering is configured on the PDCP SDUs (102a-d) expect the PDCP headers (104a-d) to avoid security breaches and add privacy to the PDCP SDUs (102-d) before the transmission to the receiver. The encrypted PDCP SDUs (102-d) are combined and passed to the RLC and MAC layer for a transmission. The RLC adds its RLC header R (110) and MAC adds its MAC header M (108) to the PDU (110a) at the beginning of the PDU (110a). The PDCP Seg (112) is added to the PDCP SDUs (102a-d) for optimizing the transmission of PDCP SDUs (102a-d) when the available grants are not enough to transmit the complete PDCP SDUs.

In FIG. 1B the receiver includes PDCP Seg (112a), RLC headerR(110a) and MAC sub header M (110a).

The security procedure of ciphering is only applied on the DRBs. The DRBs are only ciphered hence the MAC-I is not generated for integrity protection at the transmitter.

At the receiver PDCP SDUs (102a-d) deciphered only when the PDCP Seg (112) from transmitter and PDCP Seg (112a) from the receiver are combined and all the segmented PDCP SDUs (102a-d) are re-assembled in an order.

FIG. 1c is a block diagram that illustrates a scenario in which 5G RAN security processing for both SRBs and DRBs, according to the prior art as disclosed herein.

Each of the PDCP SDUs (102a-d) are assigned with the PDCP headers (104a-d) that includes different SNs are placed at the beginning of the PDCP SDUs (102a-d) to ensure the PDCP SDUs (102a-d) are confidential and correct order received at the receiver (100b). The SNs are used as input to generate the MAC-Is (106a-d) for each of the PDCP SDUs (102a-d) and placed at the end of each of the PDCP SDUs (102a-d). The generated MAC-Is (106a-d) are added as optional for the DRBs but for the SRBs the MAC-Is (106a-d) are essential in the 5G. The security operation ciphering is configured on the PDCP SDUs (102a-d) with MAC-Is (106a-d) expect the PDCP headers (104a-d) to avoid security breaches and add confidentiality to the PDCP SDUs (102a-d) before the transmission to the receiver. The security operation ciphering is configured on the PDCP SDUs (102a-d) with MAC-Is (106a-d) expect the PDCP headers (104a-d) to avoid security breaches and add confidentiality to the PDCP SDUs (102a-d) before the transmission to the receiver. The encrypted PDCP SDUs (102a-d) are passed to the RLC layer. The RLC adds its RLC header R (110) to the each of the PDCP SDUs (102a-d) for optimizing data transmission, identifying and tracking data segments at receiver. The encrypted PDCP SDUs (102a-d) with RLC header R (110) are passed to the MAC layer. The MAC layer adds its MAC header M (108) to the each of the PDCP SDUs (102a-d) and combines to form the PDU (110a).

In the 5G RAN security processing as shown in the FIG. 1C, at the transmitter, configuring security parameters on the SRBs and the DRBs, wherein the integrity protection of the security parameter is optional for the DRBs. The receiver deciphers the PDCP SDUs (102a-d), wherein decryption occurs upon the combination of PDCP Seg (112) from the transmitter and PDCP Seg (112a) from the receiver, resulting in the reassembly of all segmented PDCP SDUs (102a-d) in an order, when segmented. When packets are received completely, the reassembly is not required to be performed and the security operations can be performed directly on the completely received SDUs, once they are declared valid by the lower layers.

In the 5G RAN security processing as shown in FIG. 1C, the receiver deciphers and validates only when all the SDUs are received and reassembled in an order. The waiting time is more with respect to reassembly and the when packet loss occurs in between, the whole packet needs to be retransmitted that leads to unnecessary resource consumption, increases cost, the receiver has to wait for all the segments to be received and the packet cannot be processed by the higher layers.

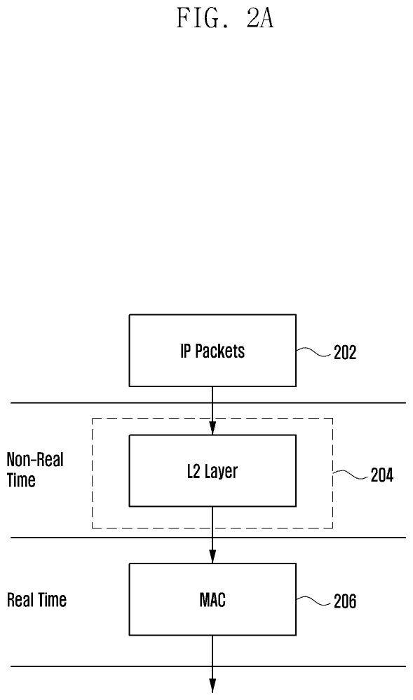

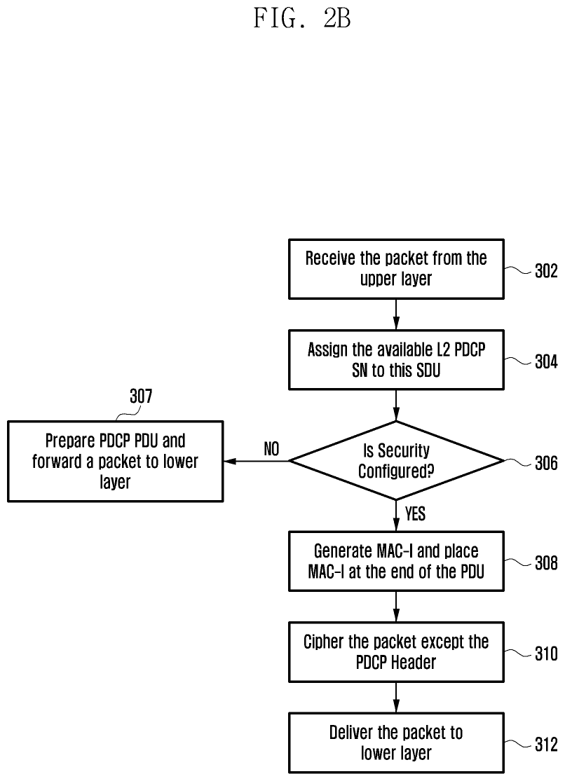

FIG. 2a is a block diagram that illustrates a Converged Layer2 (CL2), according to the prior art as disclosed herein. IP packets (202) are transmitted from a higher layer to the L2 (204) in non-real time. The L2 (204) is the CL2 used to concatenate the multiple SDUs (202) into a single L2 PDU (110a) in the LTE and the 5G. The concatenated SDUs are passed to the MAC layer in a real time. The MAC layer adds MAC header M (108) with source and destination MAC addresses. The converged layer also adds other protocol functionalities like header preparation and parsing, single windowing mechanism, soft-real time processing, non-real time processing, recovery mechanisms and retransmissions, efficient reassembly in case of segmentation, duplicate detection, data security enhancements, header compression, de-compression and the like. At CL2 in the transmitter, like in LTE and 5G, the security operations are applied on the entire cluster PDU (110a). The receiver performs the security operations only when the PDU (110a) is received. The receiver does not perform the security operations when the IP packets (202) are missed or not received segments in the order.

FIG. 2b is a flow diagram that illustrates NR procedures for assigning different SNs to each PDCP SDUs, according to the prior art as disclosed herein. Each PDCP SDU (102a-d) is assigned a unique SN prior to configuring the security parameters. Once these parameters are set, the PDU (110a) is constructed and equipped with MAC-Is (106a-d) and PDCP headers (104a-d). The resulting PDU (110a) is then encrypted, excluding the PDCP headers (104a-d), and transmitted to the lower layer. This layer, which is responsible for transmitting data from the transmitter to the receiver, receives the PDU (110a) along with its MAC-Is (106a-d).

At step 302, the PDCP SDUs (102a-d) are transmitted from an upper layer to the L2 to establish the security configuration. The network protocol stack comprises of distinct layers with designated functions, and communication between these layers is well-organized. The upper layer pertains to the data link layer or any layer above L2. The Network Layer, Transport Layer, Session Layer, Presentation Layer, and Application Layer are all upper layers, each with independent functionalities. Routing and flow control are among the functions of upper layers, which determine the path for packets to travel from source to destination and manage the rate of data transmission, respectively.

At 304, the NR PDCP receives the PDCP SDUs (102a-d) and assigns a distinct SN to each of them. The PDCP header (104a-d) is placed at the start of the PDCP SDUs (102a-d) along with the SN, which serves as an identifier for the PDCP SDUs (102a-d). These SNs are crucial in segmenting the PDCP SDUs (102a-d) transmitted from the transmitter and identifying each of them. During security operations, the receiver tracks and reassembles the PDCP SDUs (102a-d) based on their assigned SNs.

At step 306, the SN handles the configuration of security measures for PDCP Service Data Units (SDUs) 102a-d. It verifies whether each PDCP SDU is equipped with the necessary security protocols. Once the presence of security is confirmed, the SN combines the PDCP SDUs to create a Protocol Data Unit (PDU) 110a. The SN then applies ciphering and integrity protection to further enhance the confidentiality of data transmission from the transmitter to the receiver.

At step 307, when the security is not configured on the PDCP SDUs (102a-d), the PDU is formed by combining the PDCP SDUs (102a-d) and forwards to the lower layer without applying encryption and integrity protection. The lower layer is the physical layer receives the PDU (110a) to transfer from the transmitter to the receiver for operating the security operations at the receiver.

At step 308, the security configured PDCP SDUs (102a-d) are concatenated to forms the PDU (110a). The SNs are used as input to generate the MAC-Is (106a-d) for the PDU (110a) and placed at the end of the PDU (110a). In NR or 5G the MAC-Is (106a-d) are optional for the DRBs but for the SRBs the MAC-Is (106a-d) are essential. The MAC-Is (106a-d) provides integrity protection for transmission of the PDU (110a) from the transmitter to receiver to validate the transmitted PDU (110a) to avoid security breaches.

At step 310 and 312, the security operation ciphering is configured on the PDCP SDUs (102a-d) with MAC-Is (106a-d) expect the PDCP headers (104a-d) in the PDU (110a) to avoid security breaches. The PDCP headers (104a-d) is added to the PDCP SDUs (102a-d) to add in order transfer and the security functions guarantee privacy and confidentiality to the PDCP SDUs (102a-d) before the transmission to the lower layer. The lower layer is the physical layer. The lower layer receives the ciphered and the integrity protected PDU (110a) to transfer from the transmitter to the receiver for operating the security operations at the receiver device.

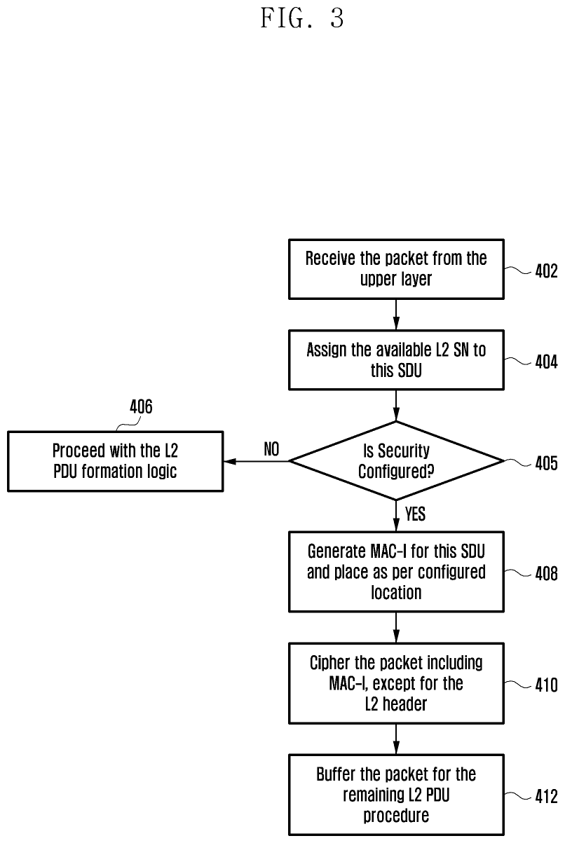

FIG. 3 is a flow diagram that illustrates performing security measures for every SDU in managing the security of concatenated packets within a telecommunication network, according to the embodiment as disclosed herein.

At step 402, the packets or SDUs (502-508) are received from an upper layer to the L2 to configure the security operations. The layers in the network protocol stack performs specific functions, and communication between the layers is structured. The upper layer refers to a layer above the L2 or a data link layer. The layers perform independent functionalities, the upper layer functions are but not limited to routing and flow control. The routing determines path for the packets to travel from the higher layer to lower layer. The flow control manages the rate of data transmission.

At 404, the SDUs (502-508) are received at L2 layer, assigned the same SN for each of the SDUs (502-508) in the L2 layer. The SN is an identifier associated with the SDUs (502-508). The SN are used to identify each of the SDUs (502-508), segment the SDUs (502-508) transmitted from the transmitter device. The receiver device tracks and reassembles the SDUs (502-508) based on the assigned SN for the security operations.

At steps 405, the SDUs (502-508) are assigned with PDCP headers (104a-d) including the same SN, checked the security is configured or not on the SDUs (502-508). When the security is configured on the each of the SDUs (502-508) are ciphered and integrity protected for adding more confidentiality to the data transfer from the transmitter device (130) to the receiver device (140). At step 406, when the security is not configured on the SDUs (502-508), the PDU (520c) is formed by combining the SDUs (502-508) without ciphering and integrity protection. The security parameters at the CL2 are not performed.

At step 408, the SNs are used as input to generate the MAC-Is or first label unique security signatures (510-516) for each of the SDUs (502-508). The MAC-Is (510-516) are generated by using input parameters like a COUNT, a DIRECTION, a CIPHERING KEY, a location of the SDUs, and a BEARER. The MAC-Is (510-516) can be placed in one of the beginnings of the SDUs (502-508) or at the end of the SDUs (502-508) or all the MAC-Is (510-516) are placed at the beginning of the PDU or all the MAC-Is (510-516) are placed at the end of the PDU. In 6G the MAC-Is (510-516) are assigned to both the DRBs and the SRBs. The MAC-Is (510-516) provides integrity protection for transmission of the SDUs (502-508) from the transmitter device (130) to the receiver device (140) to validate the transmitted PDU (520c) to avoid security breaches.

At step 410, the MAC-Is (510-516) included in the SDUs (502-508) are combined to form the PDU (520c), add the L2 header (518) and Length Indicator (LI) (530) at the beginning of the PDU (520c). The LI (530) field indicates length of the PDU (520c) including the length of the SDUs (502-508) and length of the MAC-Is (510-516). The LI (530) indicates the length of the data payload or the entire PDU (520c) of the transmitted data. The L2 header (518) is a data link layer component provides frame delimiting, error detection, flow control, encapsulating the payload into the PDU. The PDU (520c) is encrypted each SDUs (502-508) packet of the plurality of SDU packets (502-508) and the first label unique security signature corresponding to each SDU packet of the plurality of SDU packets (502-508), except for the L2 header (518) and the LI (530) and passed to the MAC layer.

At step 412, the ciphered PDU (520c) is passed to the MAC layer. The MAC layer adds the MAC sub header (534) to the PDU (520c). The MAC layer is the sub layer of the L2 and responsible for controlling access to the physical network medium, MAC addresses management, and providing error detection in the transmitted data frames. The MAC layer interacts with the physical layer to facilitate the reliable transmission of data between the transmitter device (130) and the receiver device (140). The remaining each encrypted SDU packet of the plurality of encrypted SDU packets (502-508) are buffered for the further procedures of the L2 PDU (520c) when the security is not configured.

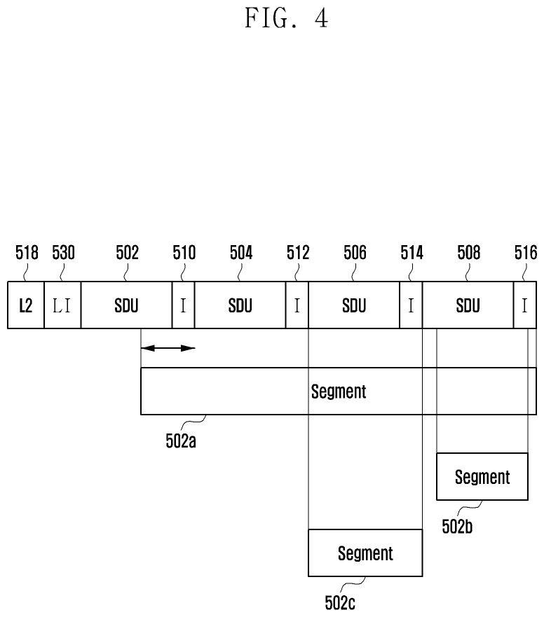

FIG. 4 is a block diagram that illustrates segmentation handling procedure for handling security of the concatenated packets in the telecommunication network, according to the embodiment as disclosed herein. The segmentation is used to divide the large data into the small manageable data pieces for efficient transmission from the transmitter device (130) to pack the data as per the available grant or the transmission opportunity and sent to the receiver device (140). The segmentation happens at the MAC layer on the available packet sizes or the SDUs (502-508). In the segmentation, the position of the SDUs (502-508) are used as metric for the segmentation offset for the starting byte of a payload or the SN numbering of the SDUs (502-508) in the concatenated PDU as 1st SDU, 2nd SDU, 3rdSDU and till nth SDU. In the segmented PDU, the numbering of the SDU in the segmented PDU informed in the L2 PDU header indicates location of the SDUs (502-508). The receiver device (140) receives the segmented SDUs (502-508). The receiver device (140) deciphers the received segmented SDUs (502-508) without having dependency on other segments. The SDUs (502-508) are received with the MAC-I (510), the SDUs (502-508) are deciphered and integrity verified independently irrespective of the received missing segments or received in the out of order.

The concatenated SDUs (502-508) are segmented to share with the receiver device (140). In an embodiment the segment (502a) includes the many SDUs (502-508). The SDUs (502-508) are numbered and informed to the segmentation header through the first number SDU about the position of the SDUs (502-508). The security operation can easily perform based on the informed positions. In yet another embodiment, the segment (502b) does not include the full SDUs (502-508). The full SDU is the SDU (502) with MAC-I (510) or combination of at least one SDUs (502-508) and MAC-I (510). In the absence of a complete SDU, the SDU communicates positional information through LI. In other embodiment, the segment (502c) includes the full SDU. The full SDU position is informed for the communication and performs the security operations.

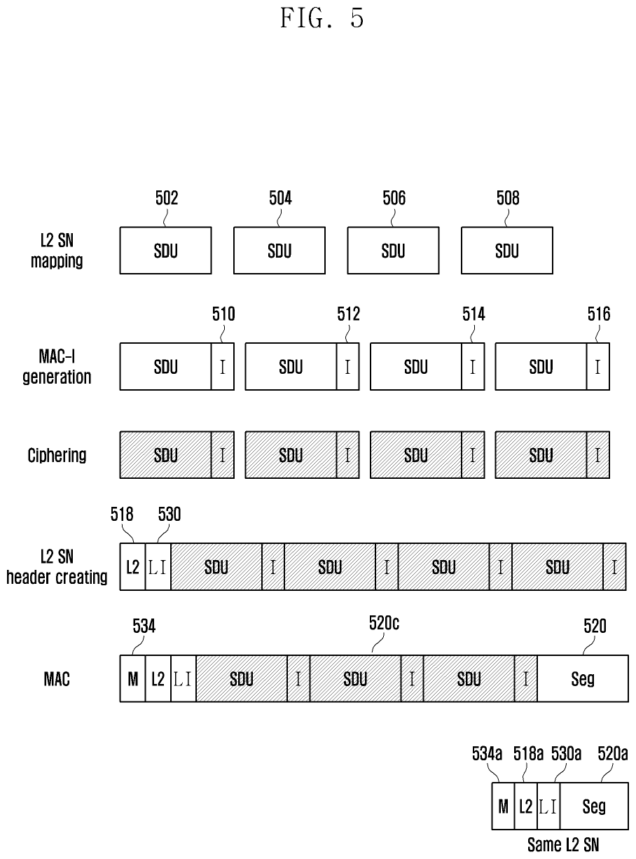

FIG. 5 is a block diagram that illustrates implementation of security parameters through the assignment of the LI field at the header location, thereby facilitating seamless security handling in the CL2 protocol stack for 6G, according to the embodiment as disclosed herein. The transmitter device (130) assigns the same SN for each of the SDUs packet of the plurality of the SDU packets (502-508) to form a single PDU (520c). The assigned SNs are used as input to generate MAC-Is (510-516) for all the SDUs (502-508) to add integrity protection or validation of each SDU packet of the plurality of SDU packets (502-508). The generated MAC-Is (510-516) are placed at the end of the each of the SDU packets (502-508). Further, the security processing unit encrypts the SDU packet (502-508) and corresponding MAC-Is (510-516), thereby ensuring an elevated level of security for each SDU packets (502-508) in the collection. After ciphering the SDUs (502-508) with MAC-Is (510-516), the PDU is formed. The PDU is included with L2 header, LI (530) and Seg (520). The L2 header includes information for routing and handling of the SDUs packets (502-508) at L2. The L2 header (518) is not ciphered because the ciphered L2 header (518) is unreadable to process and forward the SDUs packets (502-508). The LI is not ciphered because the ciphered LI (530) is unreadable and not able to provide functions for frame differentiation, efficient processing, and interoperability between the transmitter device (130) and the receiver device (140). The PDU (520c) is passed to the MAC layer. The MAC layer adds MAC sub header with source and destination MAC addresses with the Seg packet (520) to the PDU (520c).

The receiver (140) receives the segmented SDUs (502-508) including the same SNs, L2 header (518a), LI (530a), and MAC sub header (534a). The SDUs (502-508) are deciphered when the Seg (520a) packet from the transmitter device (130) and the Seg (520a) packet from the receiver device (140) are combined. The SDUs (502-508) can be deciphered independently whether the segmented SDUs (502-508) are received or not based on the included MAC-Is (510-516) for each SDU packet of the plurality of SDU packets (502-508) of the PDU.

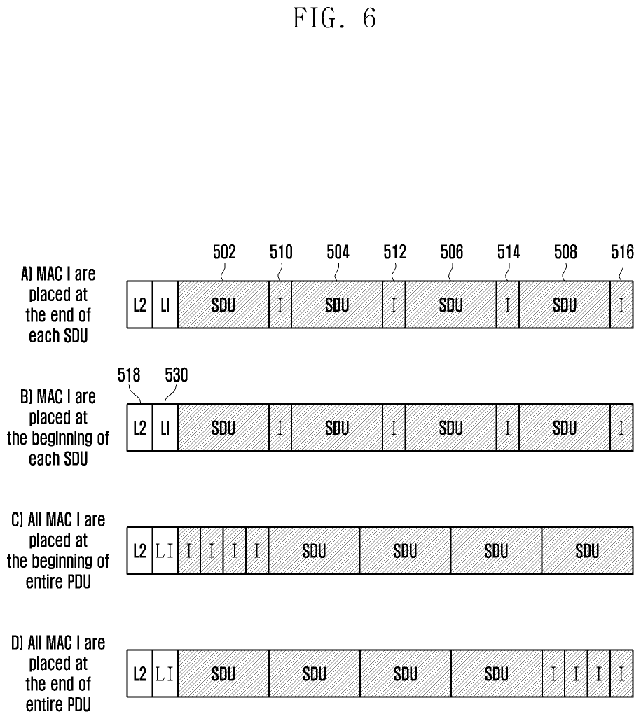

FIG. 6 is a block diagram that illustrates placement of MAC-Is at SDUs locations within the PDU for handling security of the concatenated packets in the telecommunication network, according to the embodiment as disclosed herein. The location of MAC-Is (510-516) for individual SDUs (502-508) within a single L2 PDU (520c) may be positioned suitably within the PDU. These MAC-Is (510-516) may be located after each SDU (502-508) in the PDU (520a), before each SDU (502-508) in the PDU (520c), or all MAC-Is (510-516) may be co-located together and placed at the beginning of the PDU (520a) but after the L2 Header (518) and LI (530), which are co-located together at the end of the PDU. The placement of these MAC-Is (510-516) at various positions facilitates selective authentication and adaptability to security operations.

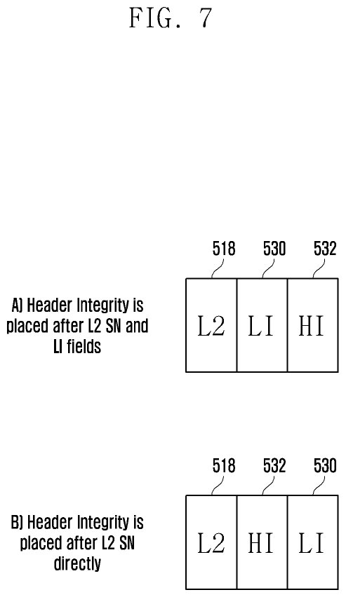

FIG. 7 is a block diagram that illustrates generating a MAC-I for both L2 and LI fields combined, serving as an extra layer of security in managing concatenated packets within the telecommunication network, according to the embodiment as disclosed herein. To enhance security, an additional measure involves creating a unique security signature, known as MAC-I as Header Integrity (HI) (532), exclusively for the L2 header field (518) and LI (530) fields. This second label is added to provide integrity protection for the L2 header (518) and LI (530). During the allocation of L2 SN and LI (530) field for the formation of the L2 PDU (520a), the HI (532) is generated for the combined L2 header (518) and LI (530) fields, positioned after the LI (530) field. The HI (532) is to be inserted in a manner that correctly fills the HI (532) value at both the transmitter device (130) and the receiver device (140), while masking its location. A reserved bit indicates the presence of the HI (532) for the L2 Header (518) and the LI (530). The placement of the HI (532) can be either before or after the LI (530) field.

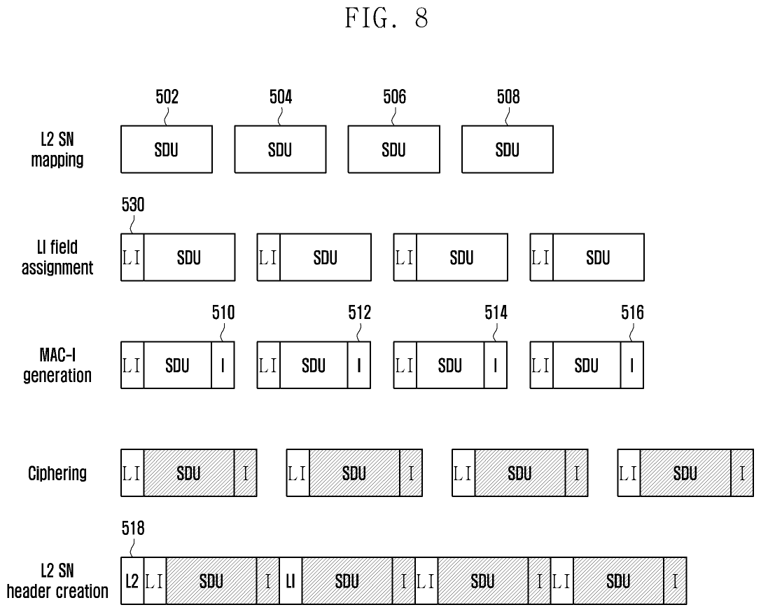

FIG. 8 is a block diagram that illustrates generating the LI for each SDUs to manage security for concatenated packets in the telecommunication network, according to the embodiment as disclosed herein. The SDUs (502-508) are assigned a common SN to form a single PDU (520c) through concatenation. Following SN assignment, the LI (530) field is created for each SDU packet (502-508) and placed at the start of the SDUs (502-508). The LI (530) field denotes the length of the SDU packets (502-508), including the MAC-Is (510-516), which are produced based on the assigned SNs to provide integrity protection to each SDU packet. The MAC-Is (510-516) are positioned at the end of each SDU packet (502-508). The SDU packets (502-508) and their corresponding MAC-Is (510-516) are further encrypted, excluding the LI (530) fields. Once the SDUs (502-508) are ciphered with MAC-Is (510-516), the PDU (520c) is formed, which includes an L2 header (518) at the start of the PDU (520c) before the LI (530) fields. The L2 header (518) is not ciphered since it would be indecipherable and therefore unable to process and forward the SDU packets (502-508). The LI (530) fields are also not ciphered since a ciphered LI (530) would be incomprehensible and incapable of providing frame differentiation, efficient processing, and interoperability between the transmitter device (130) and the receiver device (140).

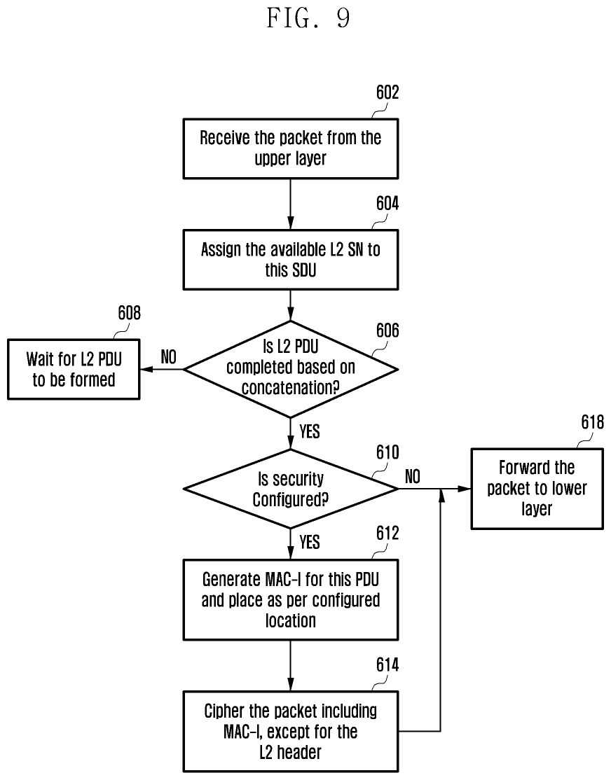

FIG. 9 is a flow diagram that illustrates a method for providing security parameters for the PDU to enhance security handling in the CL2 protocol stack for 6G, according to the embodiment as disclosed herein. The security parameters are configured on the PDU (520c) instead of each SDU packets of the plurality of SDU packets (502-508).

At step 602, the L2 receives packets or SDUs (502-508) from an upper layer in order to configure security operations. The network protocol stack is comprised of layers that perform specific functions, and communication between these layers is organized. The upper layer may refer to a layer above L2 or a data link layer, and each layer performs distinct functionalities. The upper layer has various functions, including routing and flow control, which determine the path for packets to travel from higher to lower layers and manage the rate of data transmission, respectively.

At 604, the SDUs (502-508) are received at the L2 layer and are assigned a unique SN identifier. This SN serves as a means to identify and segment each of the SDUs (502-508) transmitted from the transmitter device. The receiver device then tracks and reassembles the SDUs (502-508) based on their assigned SN, allowing for in-order operation to take place.

At step 606, the SDUs (502-508) assigned with SNs are concatenated to form the PDU (520c) prior to the security configuration. In the absence of the PDU (520c), the SDU packets (502-508) are buffered in memory until the security configurations are established.

At step 608, the SN is responsible for managing the security settings of the PDU (520c) and verifying whether security measures have been implemented. If security measures have been put in place, the PDU (520c) is processed to include additional headers that enhance its confidentiality and integrity protection. This is done in preparation for transmission from the transmitter device (130) to the receiver device (140). In instances where security measures have not been implemented, the PDU (520c) is shared with the lower layer without being ciphered or integrity protected, before being transmitted to the receiver (140).

At step 612, when the security is not configured on the SDUs (502-508), the PDU (520c) is formed by combining the SDUs (502-508) and forwards to the lower layer without applying encryption and integrity protection. The lower layer is the physical layer receives the PDU (520c) to transfer from the transmitter device (130) to the receiver (140) for operating the security operations at the receiver device (140).

At step 612, SNs serve as input parameters to generate the MAC-I (510a), which serves as a second label unique security signature for each PDU (520c). To create the MAC-I (510a), the input parameters include a COUNT, a DIRECTION, a CIPHERING KEY, the location of the SDUs, and a BEARER. The L2 header (518) is created during the formation of the PDU (520c) and is placed with the PDU (520c). The MAC-I (510a) can be positioned at the beginning or end of the PDU (520c), or it can be part of the L2 PDU Header (518). In 6G, MAC-Is (510a) are assigned to both the DRBs and the SRBs. The MAC-I (510a) is added to provide integrity protection for the transmission of the PDU (520c) from the transmitter device (130) to the receiver device (140) to validate the transmitted PDU and prevent security breaches.

At step 614, the PDU (520c) is ciphered including the MAC-I (510a) using the SN, KEY CIPHERING, Direction that is in an uplink or in a downlink of the packet transmission, location of the SDU and BEARER ID. The ciphered PDU is forwarded to the lower layer for the transmission of the PDU (520c) to the receiver device.

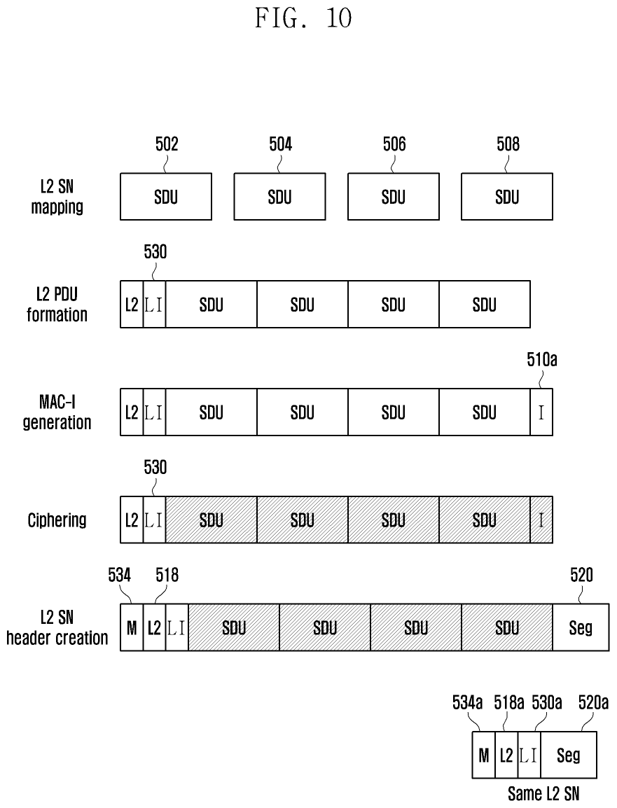

FIG. 10 is a block diagram that illustrates generation of a single LI field for PDU for security handling of the concatenated packets in the telecommunication network, according to the embodiment as disclosed herein. The transmitter device (130) assigns a uniform SN to each of the SDU packets (502-508) in the plurality of SDU packets, thereby forming a single PDU (520c). This PDU (520c) concatenates the SDUs (502-508) in the CL2, along with the L2 header (518) and a single LI (530). The assigned SNs are utilized as input to generate a single MAC-I (510a) for the PDU (520c), which adds integrity protection for the PDU (520c). The generated MAC-I (510a) is then positioned at the end of the PDU (520c). Additionally, the PDU (520c) is ciphered with its corresponding MAC-I (510a), except for the LI (530) and the L2 header (518).

The ciphered PDU (520c) is then passed to the MAC layer to add a MAC sub-header (534), which manages multiplexing and demultiplexing multiple data packets, configures and manages the lower layer and provides error detection in the transmitted data frames. The L2 header (518) includes routing and handling information for the SDUs (502-508) at L2, and is not ciphered since a ciphered L2 header (518) would be unreadable and hinder the processing and forwarding of SDUs (502-508). Similarly, the LI (530) is not ciphered since a ciphered LI (530) would be unreadable and unable to provide functions for frame differentiation, efficient processing, and interoperability between the transmitter device (130) and the receiver device (140).

Further, the Seg packet (520a) is included in the PDU (520c) to send to the receiver device (140).

The receiver device (140) receives the segmented SDUs (502-508) including the same SNs, L2 header (518), LI (530), and MAC sub header (534a). The SDUs (502-508) are deciphered when the Seg (520) packet from the transmitter device (130) and the Seg (520a) packet from the receiver (140) are combined. The SDUs (502-508) can be deciphered independently whether the segmented SDUs (502-508) is received or not based on the included MAC-I (510a) for each SDU packet of the plurality of SDU packets (502-508) of the PDU (520c).

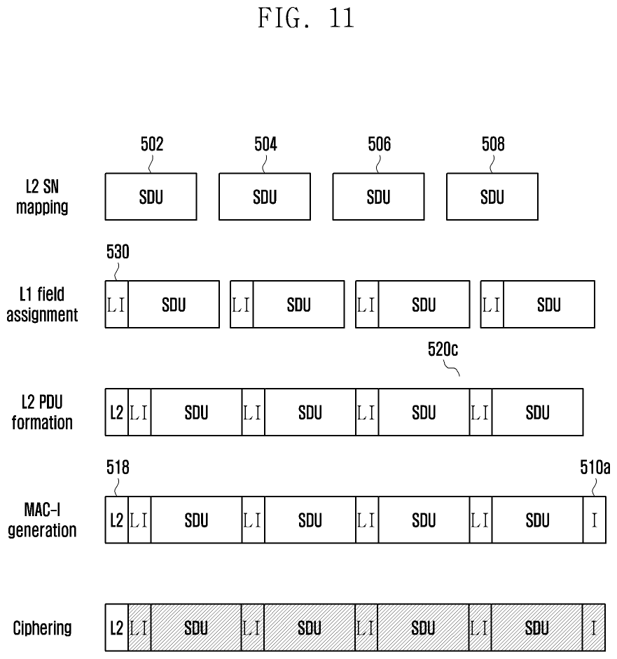

FIG. 11 is a block diagram that illustrates generation of LI fields for each SDUs and forming PDU in the telecommunication network, according to the embodiment as disclosed herein. The SDUs (502-508) are assigned with the same SN to form the single PDU. After the SN is assigned, the LI (530) field is generated for each SDU packets of the plurality of SDU packets (502-508) and placed at the beginning of the SDUs (502-508). The LI (530) fields indicates the length of the SDU packets (502-508) including the MAC-I (510a). The PDU is formed by concatenating the SDUs (502-508) with LI (530) and included the L2 header (518).

The single MAC-I (510a) is generated for the PDU (520c) by using SN as input to add integrity protection to the PDU (520c). The generated MAC-I (510a) is placed at the end of the PDU (520c). Further, ciphered the PDU (520c) with corresponding MAC-I (510a) and the LI (530) fields except L2 header (518). The PDU (520c) is included with L2 header (518) at the beginning of the PDU (520c) before the LI (530) fields. The L2 header (518) is not ciphered because the ciphered L2 header (518) is unreadable to process and forward the SDUs packets (502-508).

The security parameters can apply dynamically on the channels. The selection of the security parameters is based on condition of the channel. An Artificial Intelligence (AI) is used to select based on a good channel and a poor channel. The good channel selects the security parameters on the SDUs (502-508). The poor channel selects the security parameters on each SDU packets of the plurality of SDU packets (502-508).

The security parameters can be driven by Control Plane or MAC driving user plane configuration across the transmitter device (130) and the receiver device (140). An Artificial Intelligence (AI) can be used to select the security parameters.

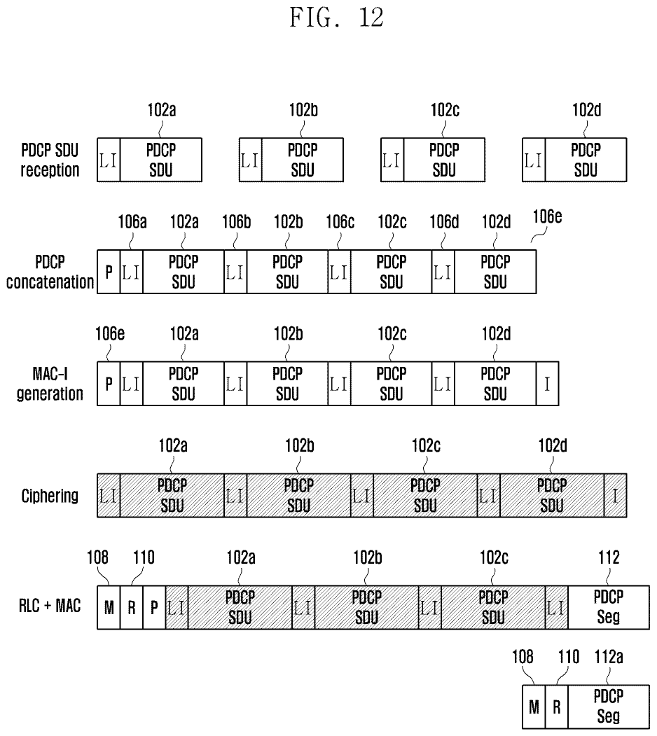

FIG. 12 is a block diagram that illustrates the application of security parameters to the PDCP concatenation in a direct manner on the 5G RAN system, according to the embodiment as disclosed herein. The LI (106a-d) fields are generated and assigned to the each of the PDCP SDUs (102a-d). The LI (106a-d) fields are indicating the length of the each of the PDCP SDUs (102a-d). The PDCP SDUs (102a-d) are concatenated with added LI (106a-d) fields. The concatenated PDCP SDUs (106f) is included the PDCP header (106e) having SN is placed at the beginning of the concatenated PDCP SDU (106f). The SN is used as input for the generation of the MAC-I (510a) and placed at the end of the concatenated PDCP SDUs (106f) and ciphered. The ciphered concatenated PDCP SDUs (106f) is passed to the RLC and MAC layer. The RLC adds its RLC header R (110) for optimizing data transmission, identifying and tracking data segments at receiver device (140). The ciphered concatenated PDCP SDUs (106f) with RLC header R (110) are passed to the MAC layer. The MAC layer adds its MAC header M (108). The PDCP Seg ( ) is added to the ciphered concatenated PDCP SDUs (106f) for optimizing the transmission of concatenated PDCP SDUs (106f) to the receiver device (140).

The receiver device (140) includes PDCP Seg (112a), R (110a) and M (108a). At the receiver device (140), concatenated PDCP SDUs (106f) deciphered only when the PDCP Seg (112) from the transmitter device (130) and PDCP Seg (112a) from the receiver device (140) are combined, all the PDCP SDUs (102a-d) have to receive in the order and reassemble to decipher the concatenated PDCP SDU.

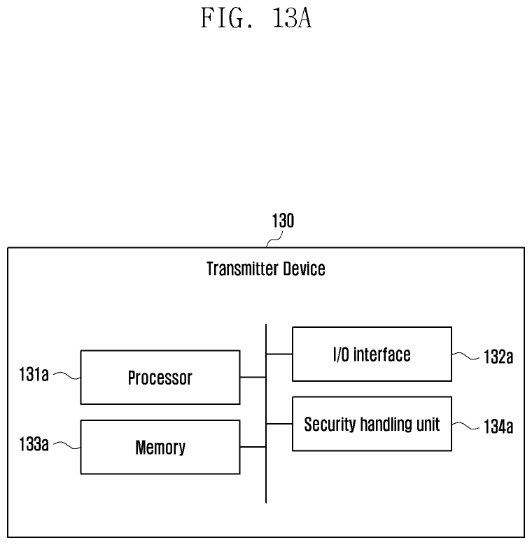

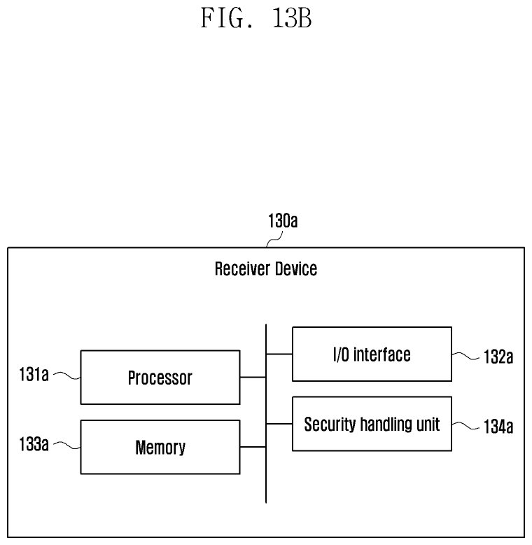

FIG. 13a is a block diagram of a transmitter device designed to manage security measures for the concatenated packets within the telecommunication network, according to the embodiment as disclosed herein. The transmitter device (130) includes a processor (131), an I/O interface (132), a memory (133) and a security handler (134). The transmitter device (130) may include, but are not limited to a base station, a data broadcasting device, a transmitting apparatus, a communication transmitters, a data transmitters, a broadcasting devices, and a communication senders. Further, the processor (131) of the transmitter device (130) communicates with the memory (133), the I/O interface (132) and the security handler (134). The processor (131) executes instructions stored in the memory (133) and to perform various processes. The processor (131) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (133) of the transmitter device (130) includes storage locations to be addressable through the processor (131). The memory (133) is not limited to a volatile memory and/or a non-volatile memory. Further, the memory (133) can include one or more computer-readable storage media. The memory (133) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (133) can store the media streams such as audios stream, video streams, haptic feedbacks and the like.

The I/O interface (132) transmits the information between the memory (133) and external peripheral devices. The peripheral devices are the input-output devices associated with the transmitter device (130). The I/O interface (132) receives several information from plurality of electronic devices. The information received from the plurality of electronic devices can include but not limited to the concatenated SDUs with the security parameters, L2 headers and length indicators.

Security handler (134) at the transmitter device (130), handles by assigning the same SNs to each SDUs (502-508) before configuring the security parameters. Following the security configuration, the PDU is formed and included with both the MAC-I and the LI field. Further, the PDU including the MAC-I is ciphered, excluding the L2 header and the LI, in preparation for transmission to the lower layer. The lower layer, namely the physical layer, receives the ciphered PDU for subsequent transmission from the transmitter (130) to the receiver device (140).

The transmitter device (130) can be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method.

FIG. 13b is a block diagram of a receiver device designed to manage security measures for the concatenated packets within the telecommunication network, according to the embodiment as disclosed herein. The receiver device (140) includes a processor (135), an I/O interface (136), a memory (137) and a security handler (138). The receiver device (140) may include, but are not limited to a User Equipment (UE), a mobile phone, a tablet computer, a notebook computer, a personal computer (Personal Computer, PC for short), an electronic device, a wireless communication device, and other terminal devices. Further, the processor (135) of the receiver device (140) communicates with the memory (137), the I/O interface (136) and the security handler (138). The processor (135) executes instructions stored in the memory (137) and to perform various processes. The processor (135) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). The received packets are parsed the header information to understand the packet is complete. The receiver validated the received SN of the packet, detect the SDU boundaries and perform security operation with decrypting first followed by integrity validation based on the security parameters used.

Further, the memory (137) of the receiver device (140) includes storage locations to be addressable through the processor (135). The memory (137) is not limited to a volatile memory and/or a non-volatile memory. Further, the memory (137) can include one or more computer-readable storage media. The memory (137) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (133a) can store the media streams such as audios stream, video streams, haptic feedbacks and the like.

The I/O interface (136) transmits the information between the memory (137) and external peripheral devices. The peripheral devices are the input-output devices associated with the receiver device (140). The I/O interface (136) receives several information from plurality of electronic devices. The information received from the plurality of electronic devices can include but not limited to the concatenated SDUs (502-508) with the security parameters.

Security handler (134a) at the receiver device (140), handles by deciphering the received SDUs (502-508) and validating irrespective of the missing segments or in order to receive the segments.

The receiver device (140) can be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method.

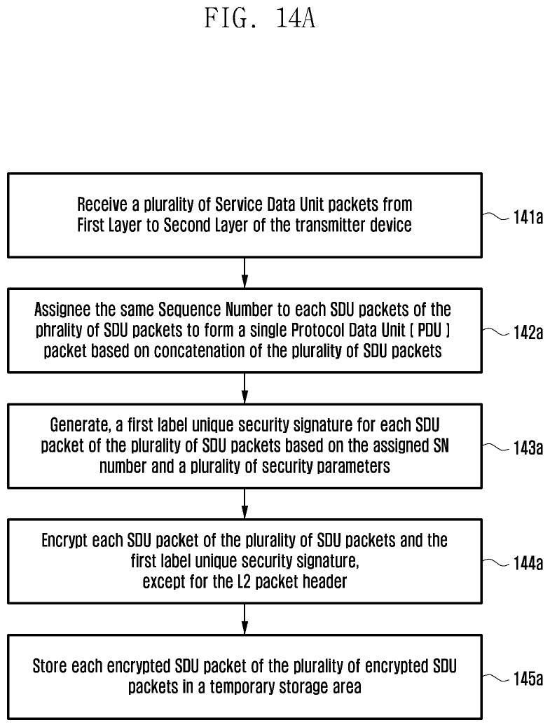

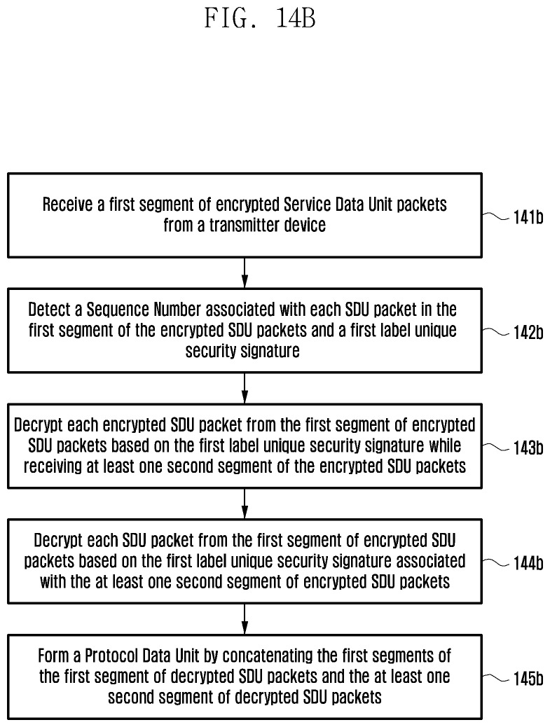

FIG. 14a is a flow diagram that illustrates a method implemented by the transmitter device for handling security for concatenated packets in a telecommunication network, according to the embodiment as disclosed herein.

At step 141a, receives a plurality of the SDUs (502-508) from upper layer to the L2 of the transmitter device (130).

At step 142a, assigns the same SN to each SDU packets of the plurality of SDU packets (502-508) to form the PDU (520c) packet based on concatenation of the plurality of SDU packets (502-508).

At step 143a, generates a MAC-I (510-516) for each SDU packet of the plurality of SDU packets (502-508) based on the assigned SN number and a plurality of security parameters.

At step 144a, encrypts each SDU packet of the plurality of SDU packets (502-508) and the MAC-Is (510-516), except for the L2 packet header (518).

At step 145a, buffers each encrypted SDU packet of the plurality of encrypted SDU packets (502-508).

FIG. 14b is a flow diagram that illustrates a method implemented by the receiver device for handling security for concatenated packets in a telecommunication network, according to the embodiment as disclosed herein.

At step 141b, receives a first segment of encrypted Service Data Unit packets (502-508) from a transmitter device (130).

At step 142b, detects the SN associated with each SDU packet in the first segment of the encrypted SDU packets (502-508) and the MAC-Is (510-516).

At step 143b, decrypts each encrypted SDU packet from the first segment of encrypted SDU packets (502-508) based on the MAC-Is (510-516) while receiving at least one second segment of the encrypted SDU packets (502-508);

At step 144b, decrypts each SDU packet from the first segment of encrypted SDU packets (502-508) based on the MAC-Is (510-516) associated with the at least one second segment of encrypted SDU packets (502-508); and At step 145b, the PDU is formed by concatenate the decrypted SDU (502-508) and the at least one second segment of decrypted SDU packets.

The present converged layer 2 concatenated SDUs (502-508) solution supports but not limited to smart header processing in header preparation or parsing, fast transfer of SDUs (502-508) in a single windowing mechanism, soft-real time processing and non-real time processing, data security enhancements, header compression, and header de-compression.

The transmitter device a reduced latency for 6G or future generation by reducing header processing for simplifying protocol stack and achieving higher throughput and lower latency. The transmitter device (130) provides security parameters for each of the SDU packets of the plurality of the SDU packets (502-508). The transmitter device (130) used the AI to select the security parameters configurations on channel condition.

The receiver device (140) can decipher the segments irrespective of the missing segments or in order of the segments received. The receiver device verifies the each of the SDU packets of the plurality of the SDU packets (502-508), rather than relying on the single payload check for the concatenated packet.

The AI model includes neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), Deep Belief Network (DBN), bidirectional recurrent deep neural network (BRDNN), Generative Adversarial Networks (GAN), and deep Q-networks.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The proposed invention offers a technical solution to security processing by eliminating the need for a complete PDU and delaying ciphering and integrity protection until the entire payload is assembled. Instead, the solution proposes a revolutionary method of conducting security operations per packet before payload formation. This involves introducing a new security header structure and incorporating fresh inputs for security key generation, such as the position of the data packet in the payload. Additionally, the invention proposes an innovative way to transition between different security modes, leveraging the benefits of security processing operations based on channel conditions.

The proposed solution holds significant technical value in the realm of developing a versatile security solution for forthcoming mobile communication technology. This is particularly relevant in scenarios where the packet payload is substantial, and security operations need to be executed on the entire payload. The process of security operations is both time-consuming and computationally intensive. However, the proposed solution discloses a more effective approach of performing security operations on smaller payload, thereby reducing the security dependency on the entire payload. To ensure the proper functioning of security measures, the complete payload of a packet must be subjected to these operations after the transmitter has generated the security key and encrypted the packet. However, due to concatenation at higher layers, it is highly probable that the packet may become segmented. As a result, security operations cannot be performed in accordance with NR specifications unless the complete packet is reassembled at the receiver. Moreover, even if a single segment is lost, the entire payload is lost, regardless of how much of the packet was affected.

The proposed solution holds significant technical value as it has the potential to become a leading contender in the realm of 6G technology or advance networks. In an embodiment, the proposed solution can be implemented and identified when the protocol headers is standardized as part of the 3GPP releases. Any logger that captures over-the-air packets of the 6G or advance network protocol can detect the packet header formats (For example, transmitter's packet formats can be used to detect it with ease). Further, the proposed solution can be detected by checking the detailed logs from either the Application Processor and/or the Modem Processor to see the internal operations for that module's processing.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a transmitter device in a wireless communication system, the method comprising:
receiving, from a higher layer, at least one service data unit (SDU) packet;
assigning, by a layer 2 (L2), a same sequence number (SN) to each SDU packet of the at least one SDU packet based on a concatenation of the at least one SDU packet;
generating a first label unique security signature for each SDU packet based on the assigned SN number and a security parameter;
encrypting each SDU packet and the first label unique security signature corresponding to each SDU packet; and
buffering, each encrypted SDU packet of the at least one SDU packet.

2. The method of claim 1, wherein buffering comprising:
adding a L2 header and a length indicator to the at least one encrypted SDU packet to form the PDU packet;
generating a second label unique security signature for a header of the PDU packet based on the assigned SN number and the security parameter; and
adding the second label unique security signature generated for the header of the PDU after or before the L2 header and the length indicator.
wherein the security parameter includes at least one a direction of an uplink and a downlink data transmission, a bearer identifier, a key integrity of each SDU packet, or a location of the at least one SDU packets in the PDU packet.

3. The method of claim 2, the method further comprising reserving at least one bit in the header of the PDU packet to indicate a presence of the second label unique security signature.

4. The method of claim 1, wherein generating comprising:
identifying whether the PDU packet is formed based on a concatenation of segments of the at least one SDU packet;
in case that the PDU packet is formed based on the concatenation, identifying whether a security option is to be performed; and
in case that the security option is to be performed, generating the first label unique security signature for each SDU packet.

5. The method of claim 1, wherein encrypting comprising:
adding the first label unique security signature to each SDU packet; and
encrypting each SDU packet and the first label unique security signature generated for each SDU packet.

6. A method performed by a receiver device in a wireless communication system, the method comprising:
receiving, from a transmitter device, a first segment of at least one encrypted service data unit, SDU, packet;
detecting a sequence number, SN, associated with each SDU packet in the first segment of the at least one encrypted SDU packet and a first label unique security signature associated with the first segment;
decrypting each encrypted SDU packet from the first segment based on the first label unique security signature while receiving a second segment of the at least one encrypted SDU packet;
decrypting each SDU packet from the first segment based on the first label unique security signature associated with the second segment; and
forming a protocol data unit (PDU) by concatenating the first segment of the first segment of the decrypted SDU packet and the second segment of the decrypted SDU packet.

7. The method of claim 6, wherein decrypting each SDU packet comprising:
removing the first label unique security signature to each SDU packet; and
decrypting each SDU packet and the first label unique security signature generated for each SDU packet.

8. The method of claim 6, wherein detecting the first label unique security signature comprising:
identifying whether a security option is to be performed; and
in case that the security option is to be performed, detecting the first label unique security signature for each SDU packet.

9. A transmitter device in a wireless communication system, the transmitter device comprising:
a transceiver; and
a controller configured to:
receive, from a higher layer, at least one service data unit (SDU) packet,
assign, by a layer 2 (L2), a same sequence number (SN) to each SDU packet of the at least one SDU packet based on a concatenation of the at least one SDU packet,
generate a first label unique security signature for each SDU packet based on the assigned SN number and a security parameter,
encrypt each SDU packet and the first label unique security signature corresponding to each SDU packet and
buffer each encrypted SDU packet of the at least one SDU packet.

10. The transmitter device of claim 9, the controller is further configured to:
add a L2 header and a length indicator to the at least one encrypted SDU packet to form the PDU packet,
generate a second label unique security signature for a header of the PDU packet based on the assigned SN number and the security parameter, and
add the second label unique security signature generated for the header of the PDU after or before the L2 header and the length indicator,
wherein the security parameter includes at least one a direction of an uplink and a downlink data transmission, a bearer identifier, a key integrity of each SDU packet, or a location of the at least one SDU packet in the PDU packet.

11. The transmitter device of claim 10, the controller is further configured to:
reserve at least one bit in the header of the PDU packet to indicate a presence of the second label unique security signature.

12. The transmitter device of claim 9, wherein the controller is further configured to:
identify whether the PDU packet is formed based on a concatenation of segments of the at least one SDU packet,
in case that the PDU packet is formed based on the concatenation, identify whether a security option is to be performed, and
in case that the security option is to be performed, generate the first label unique security signature for each SDU packet.

13. The transmitter device of claim 9, wherein the controller is further configured to:
add the first label unique security signature to each SDU packet, and encrypt each SDU packet and the first label unique security signature generated for each SDU packet.

14. A receiver device in a wireless communication system, the receiver device comprising:
a transceiver; and
a controller configured to:
receive, from a transmitter device, a first segment of at least one encrypted service data unit (SDU) packet,
detect a sequence number (SN) associated with each SDU packet in the first segment of the at least one encrypted SDU packet and a first label unique security signature associated with the first segment,
decrypt each encrypted SDU packet from the first segment based on the first label unique security signature while receiving a second segment of the at least one encrypted SDU packet,
decrypt each SDU packet from the first segment based on the first label unique security signature associated with the second segment,
form a protocol data unit (PDU) by concatenating the first segment of the first segment of the decrypted SDU packet and the second segment of the decrypted SDU packet.

15. The receiver device of claim 14, wherein the controller is further configured to:
identify whether a security option is to be performed,
in case that the security option is to be performed, detect the first label unique security signature for each SDU packet,
remove the first label unique security signature to each SDU packet, and
decrypt each SDU packet and the first label unique security signature generated for each SDU packet.
